(19) United States
(12) Patent Application Publication
(10) Pub. No.: US 2013/0006727 A1
(43) Pub. Date: Jan. 3, 2013

(54) SYSTEMS AND METHODS FOR SOCIAL FILTERING OF GEOBOOKMARKS

(75) Inventors: Andrew J. Hoag, San Francisco, CA (US); Elisha J. Fitch-Cook, Sunfield, MI (US)

(73) Assignee: Black Drumm, Inc., San Francisco, CA (US)

(21) Appl. No.: 13/430,411

(22) Filed: Mar. 26, 2012

Related U.S. Application Data
(60) Provisional application No. 61/467,585, filed on Mar. 25, 2011.
(60) Provisional application No. 61/467,596, filed on Mar. 25, 2011.

(51) Int. Cl. G06Q 30/06; G06Q 30/02; G06F 3/01

(52) U.S. Cl. 705/14.1; 715/736; 705/26.1

(57) ABSTRACT

A computer-implemented method and system of providing geobookmarks to a user of an online community are described. The method may include: displaying a graphical user interface screen on a user device, the graphical user interface screen including a location interface with a first set of geobookmarks; displaying a trust guide within the graphical user interface screen, the trust guide configured to allow the user to make a selection to filter available data; and updating the location interface with a second set of geobookmarks if the selection from the user is received.

### CROSS-REFERENCE TO RELATED APPLICATIONS

This application claims priority to U.S. Provisional Application 61/467,585, entitled SYSTEMS AND METHODS FOR SOCIAL FILTERING OF GEOBOOKMARKS, filed Mar. 25, 2011, and U.S. Provisional Patent Application No. 61/467,596, entitled SYSTEMS AND METHODS FOR ASSOCIATING COUPONS, OFFERS, AND GIFTS WITH GEOBOOKMARKS, filed Mar. 25, 2011, which are hereby incorporated by reference in their entirety.

### TECHNICAL FIELD

Various embodiments of the present disclosure generally relate to systems and methods for media filtering and manipulation. In particular, embodiments of the present disclosure relate to systems and methods for providing a user with a social filtering manipulation tool to filter geobookmarks and other media objects such as reviews, commentary, photographs, and/or other media objects from a community of users, and associate or deliver coupons, offers, and/or gifts with geobookmarks.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 illustrates an exemplary server or a client system according to one embodiment(s) of the present disclosure.

FIG. 2 illustrates a flowchart showing a set of exemplary operations 200 that may be used in accordance with another embodiment(s) of the present disclosure.

FIG. 3-6 illustrate a mobile device 300 with the media filtering and manipulation tool in accordance with yet another embodiment(s) of the present disclosure.

FIG. 7 illustrates a flowchart showing a set of exemplary operations 700 that may be used in accordance with yet another embodiment(s) of the present disclosure.

FIG. 8 illustrates a flowchart showing a set of exemplary operations 800 that may be used in accordance with yet another embodiment(s) of the present disclosure.

FIG. 9 illustrates a mobile device with a geosocial tagging application 900 with multiple geobookmarks in accordance with yet another embodiment(s) of the present disclosure.

### DETAILED DESCRIPTION

Systems and methods for media filtering and manipulation are described. In particular, various embodiments of the present disclosure relate to systems and methods for providing a user with a social filtering manipulation tool to filter geobookmarks and other media objects, and associating or delivering coupons, offers, and/or gifts with geobookmarks. In some embodiments, the social filtering manipulation tool includes a graphical user interface (GUI) for dynamic social filtering of the geobookmarks. In some embodiments, a graphical user interface (GUI) for dynamic delivery of the offers and products is provided.

In accordance with various embodiments, users of a community of platform users may store geobookmarks for locations, destinations, and/or activities (e.g., plays at a destination) they visit, together with optional data (review, commentary, photos, hyperlinks, etc). Examples of locations that may be geobookmarked include, but are not limited to, parks, hiking trails, theaters, concert venues, and businesses such as restaurants, dry cleaners, and other stores. The geobookmarks may be stored/recorded manually and/or automatically. For example, the first time a user visits a new destination or location, a geobookmark may be recorded manually possibly along with a review or other data (e.g., GPS coordinates) from the user or from a mobile device. Subsequent visits may be recorded automatically by using the GPS within a mobile device to identify that a user has returned to the destination. The geobookmarks for all users are made available for viewing by each user, typically according to some social scheme (e.g., by social distance or trust level).

In other embodiments, the GPS within a mobile device may be used to automatically identify and geobookmark a user's location. In some embodiments, the automatic geobookmark will not be created unless the GPS indicates that the user is at the location for a particular amount of time, which may depend on the type of location. For example, the time spent at the dry cleaners would be less than the typical time spent at a restaurant. At a later time, the user may go back and add the additional data such as reviews and photos. In accordance with various embodiments, this may be done from the mobile device application or from a webpage associated with the community. In some cases, the applications may provide reminders to the user to add the additional data.

Some embodiments provide for a graphical user interface which may display the geobookmarks on a locational indicator such as a map. In some embodiments, the geobookmarks may be displayed as a list, or a collection. The geobookmarks for all users within the community may be made available for viewing by each user. A user may select one or more lists of geobookmarks to follow. In some embodiments, a user may group geobookmarks via the lists of geobookmarks for filtering, as well as deals and offers. In some embodiments, a user may follow geobookmarks of another user that may or may not be the user's friend, and subscribe the content of the geobookmarks.

In addition, the application may provide a “trust slider,” a “wheel,” or other GUI tool which allows the user to readily filter the available data. For example, a user may trust reviews from those with a similar profile or may be interested in reviews from other users with opposite profile features. As another example, the filter may be based on the social distance from the user. In some embodiments, the wheel may be horizontally-oriented with detents and labels at positions.

The trust slider or the wheel may provide a way for a user to select various discrete filter settings. For example, some embodiments may include one or more of the following filter settings: 1) my bookmarks, 2) my friends bookmarks, 3) friends' bookmarks that overlap with my bookmarks, 4) friends' bookmarks that don't overlap with my bookmarks, 5) everyone's bookmarks, 6) most popular bookmarks, etc. Various embodiments also allow the user to create custom settings. For example, a user may create a setting to review people within a certain age group, with a certain number and/or age of children, martial status, and/or other profile characteristics which may be similar or different than the user's.

Various systems and methods of the present disclosure allow merchants to push coupons or offers to users based on social graph information (e.g., a merchant could make an offer to all friends of a customer that frequents the merchant) by associating the offer with the geobookmarks. Some embodiments allow users to purchase gifts (or the merchant could give the user a gift) to be presented to the intended recipient through a geobookmark associated with the merchant.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Embodiments of the present disclosure may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), field programmable gate arrays (FPGAs), application-specific integrated circuits (ASICs), vehicle identity modules (VIMs), magnetic or optical cards, flash memory, or other type of media/machine-readable medium suitable for storing electronic instructions.

Moreover, embodiments of the present disclosure may also be downloaded as a computer program product or data to be used by a computer program product, wherein the program, data, and/or instructions may be transferred from a remote computer or mobile device to a requesting computer or mobile device by way of data signals embodied in a carrier wave or other propagation medium via a communication link (e.g., a modem or network connection). In some cases, parts of the program, data, or instructions may be provided by external networks such as the telephony network (e.g., Public Switched Telephony Network, cellular, Wi-Fi, and other voice, data, and wireless networks) or the Internet. The communications link may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks.

For convenience, embodiments of the present disclosure are described with reference to a media filtering and manipulation application that may be used on a mobile device, a laptop, or other computing platform. Various embodiments are applicable to other operational models and applications, including different types of computing platforms, data gathering, filtering schemes, and filtering operations. For example, the ability to sort may be different for different service tiers (e.g., free-user vs. a fee based subscription). In some embodiments, the application may be linked to, or used within, social media communities or platforms. In addition, the features of many embodiments may be accessed by users using a software package or hardware device (with associated software or firmware) which may be directly installed on or connected to an end user's computer or mobile device. In some cases, access to the software and/or hardware device may be provided through various communication connections such as the Internet.

### Terminology

Brief definitions of terms used throughout this application are given below.

The terms “connected” or “coupled” and related terms are used in an operational sense and are not necessarily limited to a direct connection or coupling.

The term “embodiments,” phrases such as “in some embodiments,” “in various embodiments,” and the like, generally mean the particular feature(s), structure(s), method(s), or characteristic(s) following or preceding the term or phrase is included in at least one embodiment of the present disclosure, and may be included in more than one embodiment of the present disclosure. In addition, such terms or phrases do not necessarily refer to the same embodiments.

If the specification states a component or feature “may”, “may”, “could”, or “might” be included or have a characteristic, that particular component or feature is not required to be included or have the characteristic.

The term “module” refers broadly to a software, hardware, or firmware (or any combination thereof) component. Modules are typically functional components that may generate useful data or other output using specified input(s). A module may or may not be self-contained. An application program (also called an “application”) may include one or more modules, and/or a module may include one or more application programs.

The term “responsive” includes completely and partially responsive.

### Exemplary Computer System

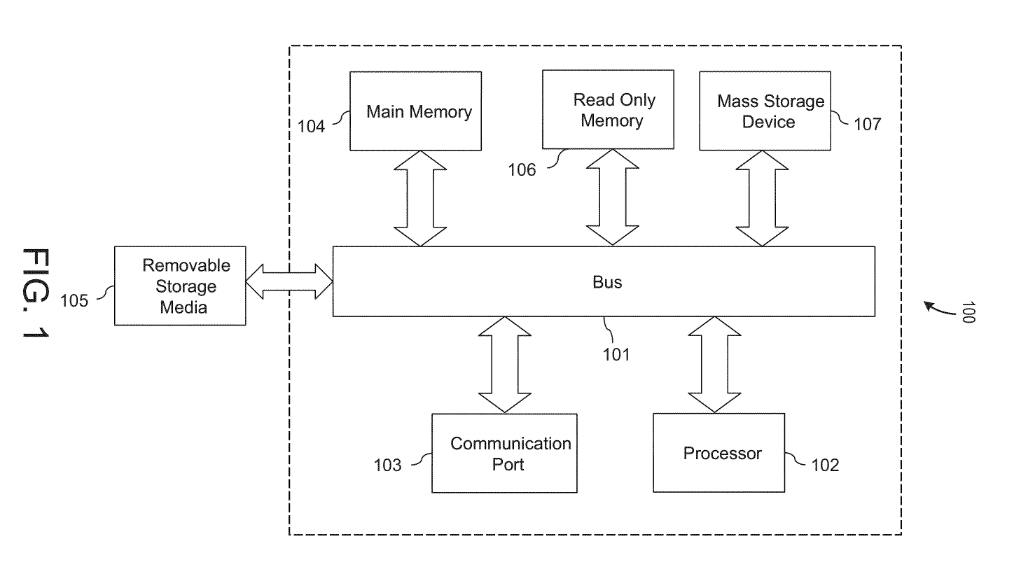

An exemplary computer system 100, representing an exemplary server or client system, with which various features of the present disclosure may be utilized, will now be described with reference to FIG. 1. In this simplified example, the computer system 100 comprises a bus 101 or other communication means for communicating data and control information, and one or more processors 102, such as Intel® Itanium® or Itanium 2 processors, coupled with bus 101.

Computer system 100 further comprises a random access memory (RAM) or other dynamic storage device (referred to as main memory 104), coupled to bus 101 for storing information and instructions to be executed by processor(s) 102. Main memory 104 also may be used for storing temporary variables or other intermediate information during execution of instructions by processor(s) 102.

Computer system 100 also comprises a read only memory (ROM) 106 and/or other static storage device coupled to bus 101 for storing static information and instructions for processor(s) 102.

A mass storage device 107, such as a magnetic disk or optical disc and its corresponding drive, may also be coupled to bus 101 for storing information and instructions.

One or more communication ports 103 may also be coupled to bus 101 for supporting network connections and communication of information to/from the computer system 100 by way of a Local Area Network (LAN), Wide Area Network (WAN), the Internet, or the public switched telephone network (PSTN), for example. The communication ports 103 may include various combinations of well-known interfaces, such as one or more modems to provide dial up capability, one or more 10/100 Ethernet ports, one or more Gigabit Ethernet ports (fiber and/or copper), or other well-known network interfaces commonly used in current or future internetwork environments. The communications ports 103 may also include specialized interfaces to provide a capability to interact with geolocation devices and/or information providing devices associated with a destination. In any event, in this manner, the computer system 100 may be coupled to a number of other network devices, clients, and/or servers via a conventional network infrastructure, such as an enterprise's Intranet and/or the Internet, for example.

Optionally, operator and administrative interfaces (not shown), such as a display, keyboard, and a cursor control device, may also be coupled to bus 101 to support direct operator interaction with computer system 100. Other operator and administrative interfaces may be provided through network connections connected through communication ports 103.

Finally, removable storage media 105, such as one or more external or removable hard drives, tapes, floppy disks, magneto-optical discs, compact disk-read-only memories (CD-ROMs), compact disk writable memories (CD-R, CD-RW), digital versatile discs or digital video discs (DVDs) (e.g., DVD-ROMs and DVD+RW), zip disks, or USB memory devices, e.g., thumb drives or flash cards, may be coupled to bus 101 via corresponding drives, ports or slots.

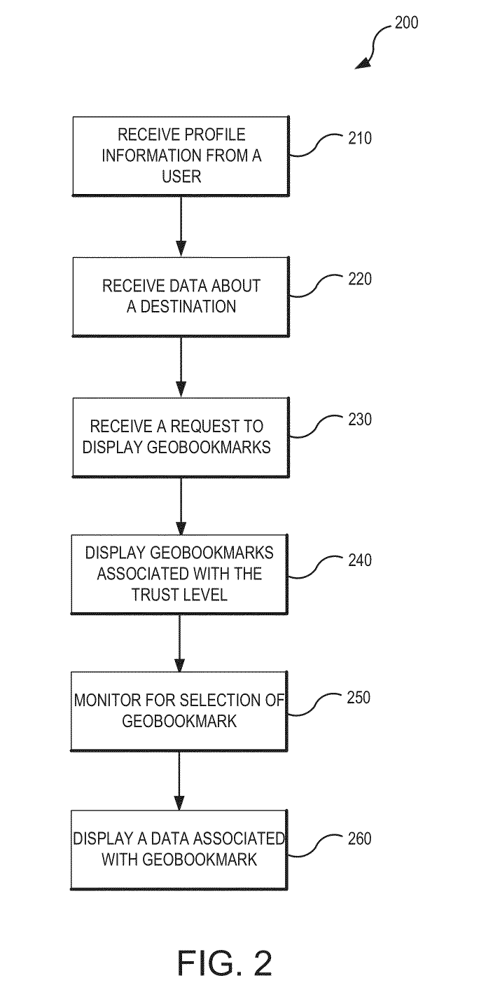

FIG. 2 illustrates a flowchart showing a set of exemplary operations 200 that may be used in accordance with one or more embodiments of the present disclosure. As illustrated in FIG. 2, profile operation 210 may receive a request from a user to join the community and setup a user profile. Various profile information may be requested from the user. Examples include, but are not limited to age, occupation, date of birth, martial status, number of children, age of children, frequency of travel, main reason for travel (e.g., business, vacation, etc), home town, favorite foods, favorite music (types or artists), preferences, and others. The profile information may also use psychological profiling questionnaires. In accordance with various embodiments, the profile information may be combined to generate custom profiles that may be used to create trust levels for filtering the geobookmarks.

Once the user is part of the community, the user may record data about a destination using recordation operation 220. This data may include pictures, reviews, commentary, GPS data, links to a website associated with the destination, phone numbers, manager names, employee names, date of the visit, length of visit, number of times visited, list of similar locations, preferences, and other information about the destination. The information may be uploaded to a geobookmarking database that may be accessed by the community.

When a user submits a request to display geobookmarks (e.g., using an application on a mobile device), the request may be transmitted to a server. Receiving operation 230 may receive the request. In accordance with various embodiments, the request may include a variety of criteria that may be used to filter, sort, and/or prioritize the data available in the geobookmark database. For example, the request may include criteria for a specific type of destination (e.g., dry cleaners) within a specific area. The request may also include a trust level. Examples include, but are not limited to, the following: 1) my bookmarks, 2) my friends bookmarks, 3) friends' bookmarks that overlap with my bookmarks, 4) friends' bookmarks that don't overlap with my bookmarks, 5) everyone's bookmarks, 6) most popular bookmarks, etc.

Using the selection criteria, the geobookmarking data may be filtered, sorted, and/or prioritized and returned to the requesting device. The requesting device may then update the geobookmarks that are displayed using updating operation 240. Then, monitoring operation 250 may monitor for the cursor movements of the user to determine if a cursor has been positioned over or in proximity to a selected geobookmark. Once monitoring operation 250 determines that the cursor has been positioned over or in proximity to a geobookmark, data display operation 260 may display the data (e.g, reviews, photos, links to website, etc).

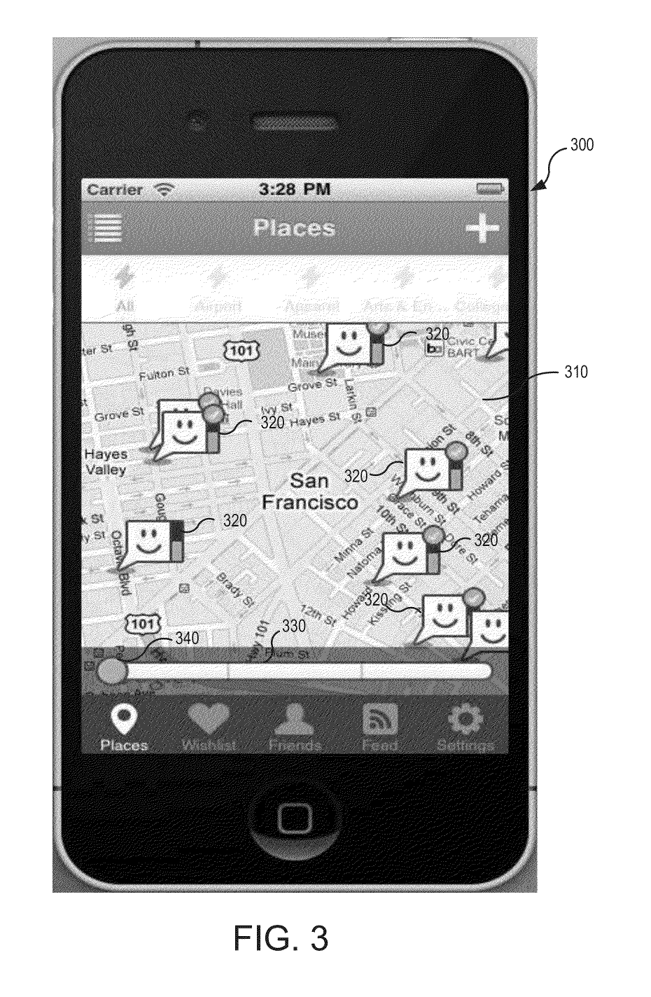

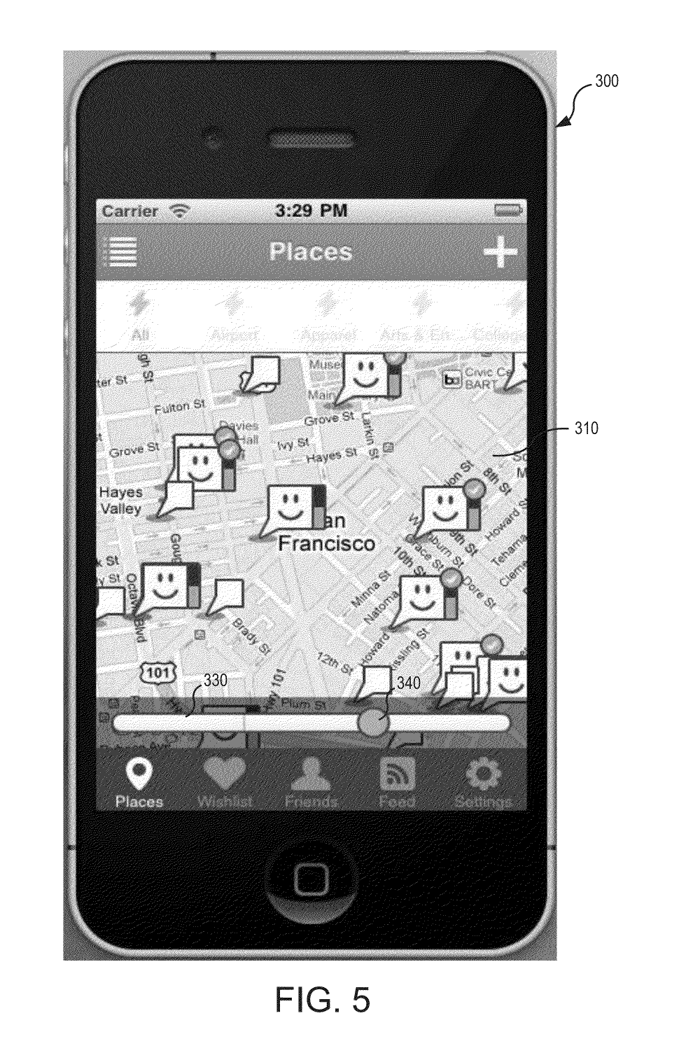

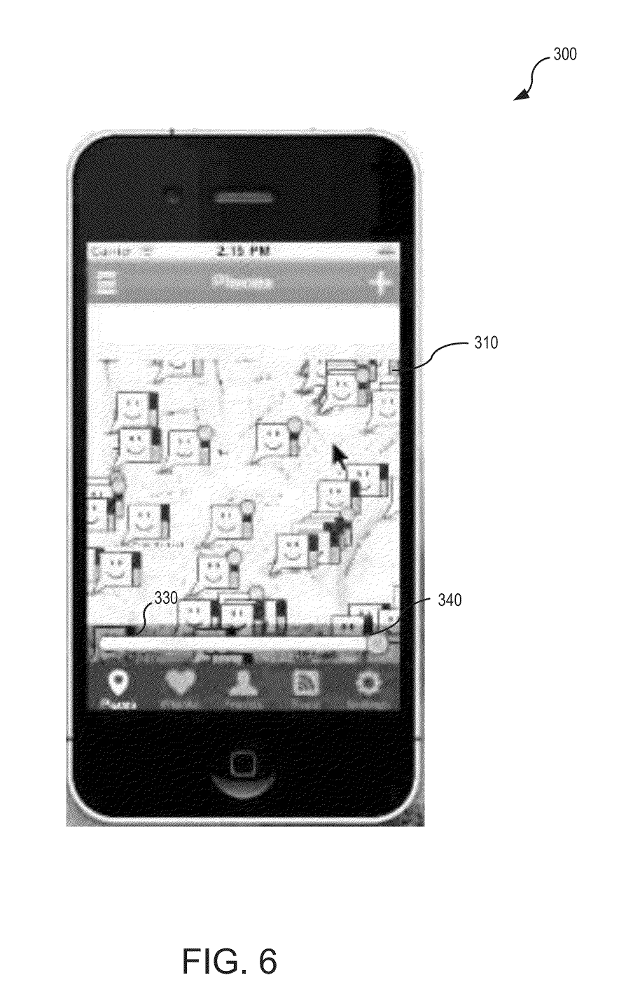

FIGS. 3-6 illustrate a mobile device 300 with the media filtering and manipulation tool in accordance with some embodiments of the present disclosure. These figures show a map 310 and various geobookmarks 320 along with a trust slider 330 with a positional indicator 340 in four different positional setting. In accordance with various embodiments, as the user slides the positional indicator 340 to the different positions, the geobookmarks are dynamically filtered. As such, as the user slides positional indicator 340 from a first position into a second position within trust slider 330 the geobookmarks are updated, removed, associated data is filtered, added, or otherwise changed in accordance to the trust level indicated by the positional indicator. In at least one embodiment, trust is simply a function of social nearness. As such, positional indicator 340 all the way to the left (FIG. 3) could be the most trustworthy, while all the way to the right (FIG. 6) could be the least trustworthy.

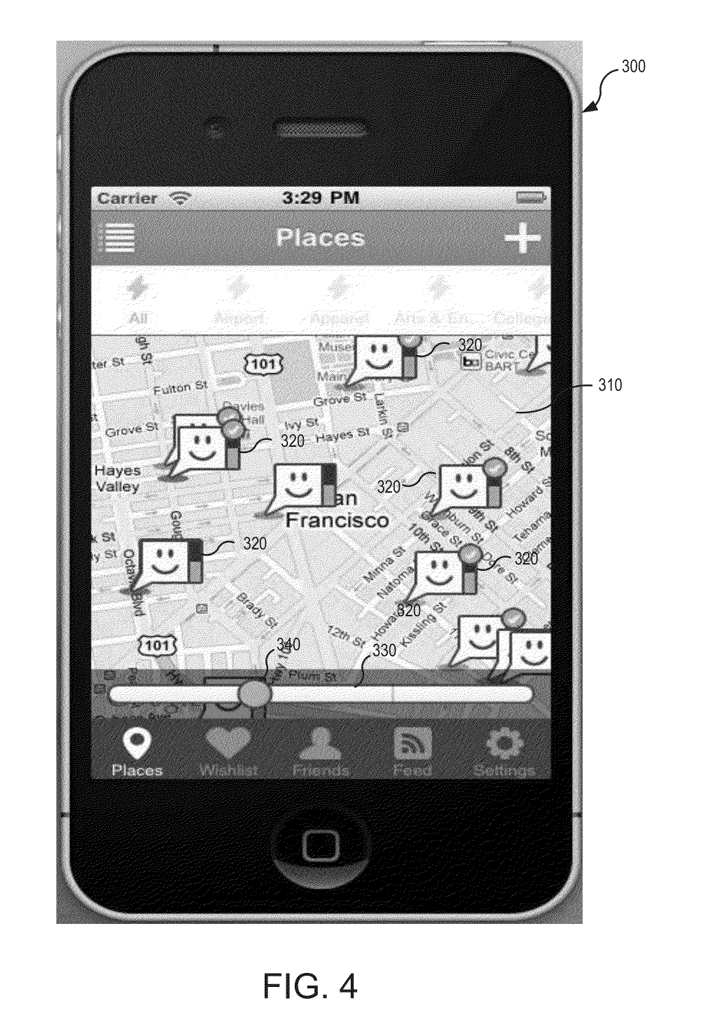

FIG. 4-6 illustrate an example of how the geobookmarking may change with changes in the selected trust level as indicated by the trust slider. As illustrated in these figures, in some embodiments, the geobookmarks may include various indicators regarding the type of destination or reviews associated with the destination. For example, a smiley face may indicate a majority of positive reviews while a frown may indicate more negative reviews. Similarly, a blank geobookmark may indicate no reviews or only reviews by the destination. In other embodiments, other types of indicators may be used. For example, a trust bar may be associated with the geobookmark indicating the level of trust or compliance with the trust level.

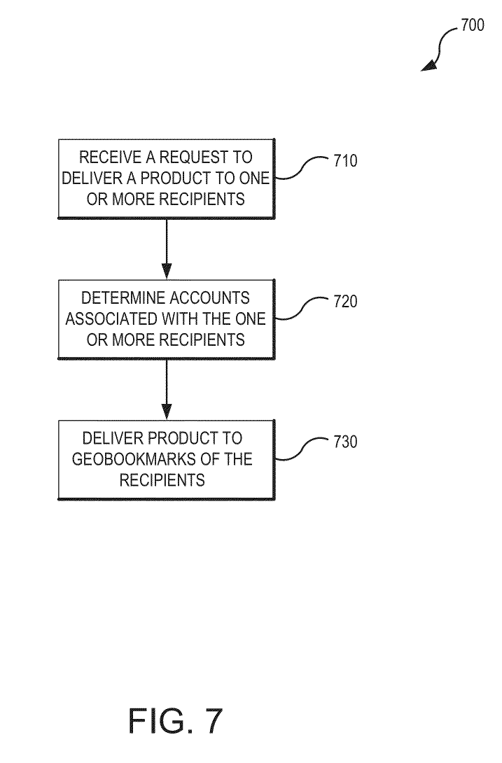

FIG. 7 illustrates a flowchart showing a set of exemplary operations 700 that may be used in accordance with one or more embodiments of the present disclosure. As illustrated in FIG. 7, receiving operation 710 may receive a request from a user or merchant to deliver a product to one or more recipients that are part of a geosocial tagging platform. The recipients may be selected in many different ways. For example, in some embodiments, when a user spends more than a certain amount of money at a merchant (e.g., restaurant), the merchant may decide to send coupons, discounts, gifts, or other offers to friends of the user. In some cases, the merchant may impose additional criteria (e.g., that the friends haven't visited the merchant before, age limits, minimum number of friends on the platform, etc) or may tie the benefit to the additional criteria (e.g., the more friends, the more valuable the discount, coupon, or offer). In other cases, the user merchant provides a fixed number of products which the user may distribute as desired by the user.

As another example, a user of the geosocial platform may decide to buy a gift for a friend or to pass along a coupon or other offer. In accordance with these embodiments, the user may select a geobookmark associated with a merchant. In response to selecting the merchant, a list of items that may be purchased may be provided. The user may select which item to purchase, which recipient, and to purchase the product.

In some embodiments, the GPS of a mobile device of a user may be used to track the location of the user. When the user visits a merchant, the GPS coordinates are used to determine the user is at that merchant. Using this information and other information recorded by the geosocial tagging application, gifts, coupons, offers, etc may be provided by the merchant. For example, the first time the user visits the merchant the merchant may provide a discount to the user. As another example, when a gift, coupon, offer, or reward may be provided to the user based on the number of visits (e.g., every tenth visit the user gets a free coffee).

Determination operation 720 may determine the accounts of the one or more recipients. This may be done, for example, by accessing a database of platform users. Once the accounts have been determined, delivery operation 730 may deliver the product to the recipients (e.g., through a geobookmark within an application interface).

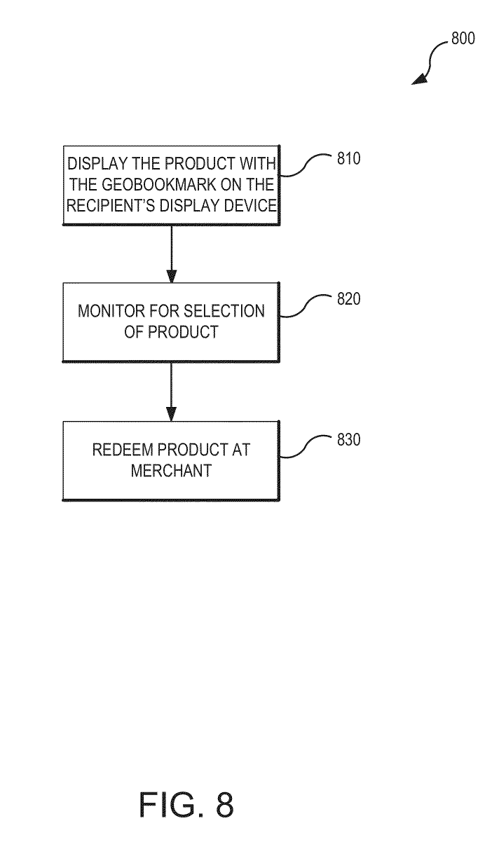

FIG. 8 illustrates a flowchart showing a set of exemplary operations 800 that may be used in accordance with several embodiments of the present disclosure. As illustrated in FIG. 8, display operation 810 may display or associate the product with the geobookmark in the recipient's account and that may be displayed on the recipient's mobile device. The geobookmark may be changed in any number of ways (e.g., color, size, changing color, flashing, etc) to indicate that a gift, coupon, offer, reward, or other product is now associated with that merchant.

Monitoring operation 820 may monitor for an indicator from the recipient to redeem the product. Once the user realizes that the product has been associated with the geobookmark, the user may select the geobookmark and the offer to redeem the product using redemption operation 830. In some embodiments, redeeming the product may include displaying a bar code that may be scanned at the merchant, displaying an alphanumeric string that may be entered at the merchant or merchant's website, requesting for physical delivery of the product, and the like.

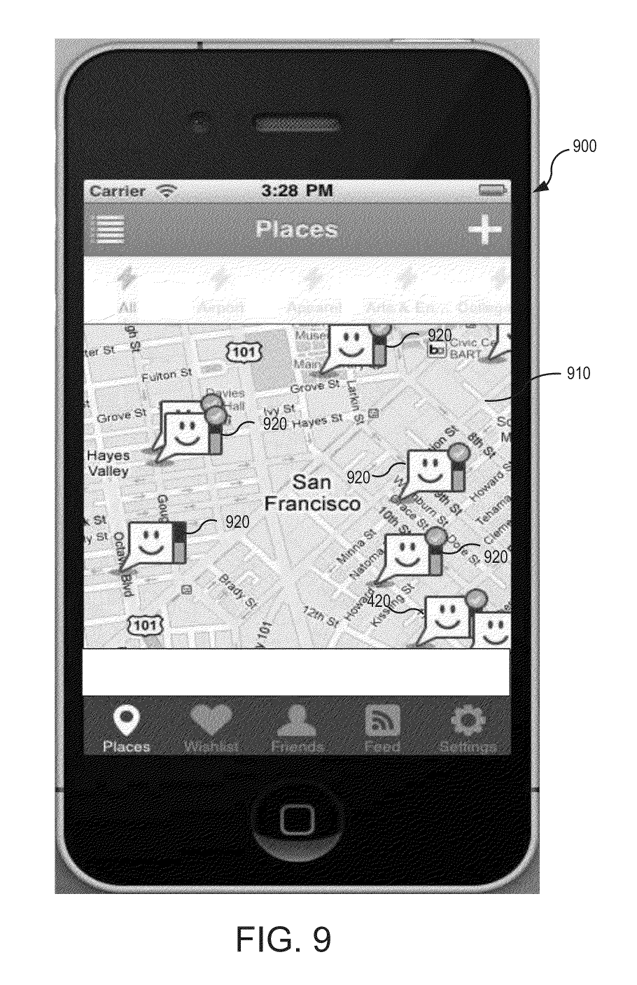

FIG. 9 illustrates a mobile device with a geosocial tagging application 900 with multiple geobookmarks in accordance with some embodiments of the present disclosure. In the embodiments shown in FIG. 9, the application may include a map 910 and various geobookmarks 920. In accordance with various embodiments, associated with the geobookmarks 920 may be various indicators regarding the type of destination or reviews associated with the destination. For example, a smiley face may indicate a majority of positive reviews while a frown may indicate more negative reviews. Similarly, a blank geobookmark may indicate no reviews or only reviews by the destination. In other embodiments, other types of indicators may be used.

Various embodiments may be implemented using a combination of one or more modules and/or system components. For example, some embodiments provide for a graphical user interface module to generate one or more graphical user interface screens configured to receive instructions, receive selection objectives, and convey results, a general-purpose or special-purpose “communications module” for interfacing with one or more other modules and devices, one or more processors, a memory store, a data store (e.g., database) for storing profile information, a data store for storing data associated with a destination, a “trust module” to receive and process a set of profile information constraints that express (e.g. mathematically) the trust level of a user who made a review or a set of trust objectives, as well as other modules and/or components for providing various functionality needed by embodiments of the present disclosure. Still yet, some embodiments may incorporate two or more of these modules and/or components into a single device and/or associate a portion of the functionality of one or more of these modules with a different module.

The illustrative embodiments described are not intended to be exhaustive, but rather to highlight some of the benefits and advantages associated with embodiments and features of the media manipulation and filtering tool. Various modifications and additions may be made to the embodiments discussed without departing from the scope of the present disclosure. For example, while the embodiments described above refer to particular features, the scope of this invention also includes embodiments having different combinations of features and embodiments that do not include all of the described features. Accordingly, the scope of the present disclosure is intended to embrace all such alternatives, modifications, and variations and all equivalents thereof.

What is claimed is:

1. A computer implemented method for providing geobookmarks to a user of an online community, the method comprising:
displaying a graphical user interface screen on a user device, the graphical user interface screen including a location interface with a first set of geobookmarks;
displaying a trust guide within the graphical user interface screen, the trust guide configured to allow the user to make a selection to filter available data; and
updating the location interface with a second set of geobookmarks if the selection from the user is received.

2. The method of claim 1, further comprising: determining the user's location by identifying the user device's geolocation, wherein the geolocation is associated with the Internet Protocol (IP) address, the media access control address, radio-frequency identification, hardware embedded article/production number, embedded software number, Wi-Fi connection location, device GPS coordinates, or other self-disclosed information.

3. The method of claim 2, wherein the user's location is automatically identified and geobookmared if the user stays at the user location over a predetermined period of time.

4. The method of claim 2, further comprising:
monitoring the user location to determine whether the user is positioned over or in proximity to a selected geobookmark in the first set of geobookmarks or the second set of geobookmarks; and
displaying data associated with the selected geobookmark.

5. The method of claim 4, wherein the data includes pictures, reviews, commentary, GPS data, links to a website, phone numbers, manager names, employee names, date of the visit, length of visit, number of times visited, list of similar locations, or preferences associated with the selected geobookmark.

6. The method of claim 1, wherein the trust guide is a sliding bar or a wheel.

7. The method of claim 1, wherein the trust guide includes a first positional setting configured to display geobookmarks corresponding to the user's bookmarks, a second positional setting configured to display geobookmarks corresponding to bookmarks of the user's friends, a third position setting configured to display geobookmarks corresponding to the user's friends' bookmarks that overlap with the user's bookmarks, and a fourth positional setting configured to display geobookmarks corresponding to the user's friends' bookmarks that don't overlap with the user's bookmarks.

8. The method of claim 7, wherein the trust guide further includes a fifth positional setting configured to display geobookmarks corresponding to bookmarks from all users of the online community; and a sixth positional setting configured to display geobookmarks corresponding to most popular bookmarks.

9. The method of claim 1, wherein the trust guide includes a custom setting configured to display geobookmarks from people within a user-defined group.

10. The method of claim 9, wherein the user-defined group is determined by age, marital status, the number of children, the age of children, and/or other profile characteristics similar or different from the user's.

11. A computer implemented method for providing geobookmarks to a user of an online community, the method comprising:
receiving a set of data about one or more destinations from the user and/or other users within the online community;
receiving a request to populate the geobookmarks on a user device of the user with at least a subset of the set of data, the geobookmarks associated with the one or more destinations; wherein the request includes a level of trust; and
transmitting the subset of data that comply with the level of trust to the user device.

12. The method of claim 11, further comprising: determining the user's location by identifying the user device's geolocation; wherein the geolocation is associated with the Internet Protocol (IP) address, the media access control address, radio-frequency identification, hardware embedded article/production number, embedded software number, Wi-Fi connection location, device GPS coordinates, or other self-disclosed information.

13. The method of claim 12, further comprising:
monitoring the user location to determine whether the user is positioned over or in proximity to a selected destination of the one or more destinations; and
displaying information associated with the selected destination on a graphical user interface screen of the user device.

14. The method of claim 13, wherein the information includes pictures, reviews, commentary, GPS data, links to a website, phone numbers, manager names, employee names, date of the visit, length of visit, number of times visited, list of similar locations, or preferences associated with the selected destination.

15. The method of claim 11, wherein the level of trust is a function of social nearness.

16. An apparatus, comprising:
one or more processors; and
a computer-readable storage medium storing one or more computer programs which, when executed by the one or more processors, cause the one or more processors to perform a set of operations for providing geobookmarks to a user of an online community, the one or more computer programs comprising:
instructions to display a graphical user interface screen on a user device, the graphical user interface screen including a location interface with a first set of geobookmarks;
instructions to display a trust guide within the graphical user interface screen, the trust guide configured to allow the user to make a selection to filter available data; and
instructions to update the location interface with a second set of geobookmarks if the selection from the user is received.

17. The apparatus of claim 16, further comprising: instructions to determine the user's location by identifying the user device's geolocation, wherein the geolocation is associated with the Internet Protocol (IP) address, the media access control address, radio-frequency identification, hardware embedded article/production number, embedded software number, Wi-Fi connection location, device GPS coordinates, or other self-disclosed information.

18. The apparatus of claim 17, further comprising:
instructions to monitor the user location to determine whether the user is positioned over or in proximity to a selected geobookmark in the first set of geobookmarks or the second set of geobookmarks; and
instructions to display data associated with the selected geobookmark.

19. The apparatus of claim 18, wherein the data includes pictures, reviews, commentary, GPS data, links to a website, phone numbers, manager names, employee names, date of the visit, length of visit, number of times visited, list of similar locations, or preferences associated with the selected geobookmark.

20. The apparatus of claim 19, wherein the trust guide includes a custom setting configured to display geobookmarks from people within a user-defined group.

21. A computer implemented method, comprising:
receiving a request to deliver a product to one or more recipients of a geosocial tagging platform through a geobookmark associated with a merchant;
determining the accounts in the geosocial tagging platform that are associated with the one or more recipients; and
associating the product with the geobookmark of the merchant within the accounts of the one or more recipients.

22. The method of claim 21, wherein the request originates from a merchant or from a user.

23. The method of claim 22, wherein the one or more recipients are selected from a set of friends associated with the user within the geosocial tagging platform.

24. The method of claim 21, further comprising:
detecting a user of the geosocial tagging platform spends more than a certain amount at a merchant; and
wherein, in response to detecting the user spends more than the certain amount, the merchant requests delivery of a product to one or more friends associated with the user within the geosocial tagging platform.

25. The method of claim 21, wherein the product is a coupon, an offer, a discount, a credit, reward, or a gift card that is redeemable at the merchant.

26. The method of claim 21, wherein the request originates from a user of the geosocial tagging platform and the product is a gift purchased by the user.
